(19) United States
(12) Patent Application Publication
(10) Pub. No.: US 2020/0288553 A1
(43) Pub. Date: Sep. 10, 2020

(54) Simplified electronic protection circuit for LED luminaires for horticultural applications

(71) Applicant: Robert W. McCullough, Sausalito, CA (US)

(72) Inventor: Robert W. McCullough, Sausalito, CA (US)

(21) Appl. No.: 16/881,683

(22) Filed: May 22, 2020

(51) Int. Cl. H05B 45/56; H05B 47/28; H05B 45/54; H05B 45/345

(52) U.S. Cl. CPC H05B 45/56; H05B 45/345; H05B 45/54; H05B 47/28

(57) ABSTRACT

Electrical current conditioning systems may include simplified electronic protection circuits for LED lights used for growing plants. A system includes an LED support structure with a channel extending therethrough, and an LED array module carried on a surface of the LED support structure. The LED array module includes an LED array and a current conditioning circuit which adjusts the amount of current flowing through the LED array in response to a temperature indication. The current conditioning circuit includes a current sensing circuit which adjusts the amount of current flowing through the LED array in response to a voltage indication.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to electronic protection circuits. More particularly, the invention relates to the design, manufacture and use of simplified electronic protection circuits sometimes used in horticultural applications.

### (2) Description of the Related Art

The use of LED luminaires and use of regulated power supplies are known in the prior art and have become over evolved and an efficient over engineering for the needs of horticultural uses.

In the related art, electronic driver circuits for LED lighting have evolved from the requirements of the lighting industry, as applied to enable humans to view objects, as by far the largest market segment for LEDs. In human viewing related applications, there is a critical for light quality to be carefully controlled and maintained to insure high quality illumination for illuminating products such as food and clothing and to maintain ambient conditions for space lighting. LED manufacturers go to great lengths to assure uniform performance in their products. In addition, in traditional LED applications, it is well known that the color spectrum and intensity of LEDs varies critically with the amount of current passing through the device, thus causing the related art to design ever increasingly complicated systems of power regulation.

As a result, the human viewing design paradigm for LED luminaires has evolved an electronic architecture designed to maintain precise long-term control of the current supplied to LEDs in the fixture. Typically this design incorporates at the first level a highly regulated constant voltage power supply, mainly incorporating “switching power supply” technology. The output of this power supply then powers a second level of electronic circuitry that controls the current to the LEDs, which may be arranged in several arrays or “strings”. Finally the output of the current controlling circuitry is connected to the LED array, possible on a separate circuit board from the driver.

This prior art architecture functions well for the lighting needs of human viewers and consequently has been adapted widely in the lighting industry. However, the multiplicity of layers results in a complex and costly system.

The related art eschews the less stringent needs of horticultural applications, wherein the main objective of the lighting system is to provide photons to the plant to be used in the process of photosynthesis, which includes nutrient production and plant regulation. The molecules responsible for these two processes absorb photons over a relatively broad region of the light spectrum, generally between 400 nm and 700 nm. LEDs have found favor in this industry as a blend of colors that efficiently drive the process and can be configured from monochromatic LEDs. For example, it is believed that red photons at about 660 nm and blue photons at 450 nm are well suited for driving the photosynthesis process of the chlorophyll molecules.

LEDs operating monochromatically typically produce output spectra with a full-width half-maximum (FWHM) of 25 nm. The variation in the peak emission wavelength of the LEDs also varies within about 20 nm. In addition, as the current driving the LEDs varies, the center wavelength can also shift. Fortunately the absorption characteristics of the chlorophyll molecule exhibit a broad absorption band with a half-width of 70 nm or more. The result is that the plants are not that sensitive to the exact wavelength being absorbed in their production. This is primarily because they have evolved to use the photons from the broad spectrum of the sun.

Consequently, incorporating the complicated electronic architecture from the lighting industry into a horticultural lighting is not necessary and indeed increases cost. What is needed is the simplest circuit that addresses the needs of the LEDs. What are those needs? Simply put, the LED needs to have a circuit that limits the maximum current that passes through it and that protects the LEDs from overheating if the cooling system shuts down or fails. LEDs are not sensitive to variations in current and plants are not sensitive to minor fluctuations in the light intensity. The phenomenon of “flicker” which is extremely serious in lighting has no bearing in a horticultural light, other than the possible irritation of humans tending to the plants.

Thus, there is a need in the art for the presently disclosed embodiments that use simplified designs in power management and system protection that comport with the more hardy lighting requirements of horticulture.

### BRIEF SUMMARY OF THE INVENTION

The present invention overcomes shortfalls in the related art by presenting an unobvious and unique combination, configuration and use of components and designs to produce cost effective lighting systems that take advantage of the more robust tolerances of plant life.

The known related art fails to disclose, suggest or teach the use of the disclosed electrical power systems, electrical circuits and other disclosed components that may include the use of a supply voltage in the low voltage DC range (less than 60 VDC). Most of the circuits described above as within the related or prior art are powered by 120-240 VAC power which is much more dangerous, especially in a greenhouse environment which may involve workers standing in ground water while touching fixtures. The presently disclosed designs overcome this prior art short fall and may include designs that incorporate a plurality of small circuits employing 10 to 20 LEDs. Each small circuit may be protected by its own simple circuit that uses fewer than 10 inexpensive elements. In the event that one of the small circuits should fail, operation of the balance of the circuits is unaffected. A typical fixture of 1000 watts may incorporate 40 of the small circuits.

Further advantages over the prior art are achieved my use circuits that may comprise an electronic switch (MOSFET), which is controlled by a pair of transistors. One transistor senses the current by means of a current-sensing resistor. The other transistor senses the temperature of the circuit board by means of a resister with a high sensitivity to temperature (a thermistor). This circuit was perfected by numerous iterations of test circuits and has been incorporated in hundreds of LED fixtures successfully.

The presently disclosed embodiments may include electrical current conditioning systems which provide desired currently signals to drive one or more LEDs within tolerances acceptable for the growth of plants.

### BRIEF DESCRIPTION OF THE DRAWINGS

FIG. 1 is a block diagram of a current conditioning system.

FIG. 2 is a circuit diagram of a first current conditioning circuit, which corresponds to the current conditioning system of FIG. 1.

FIG. 3 is a circuit diagram of a second current conditioning circuit, which corresponds to the current conditioning system of FIG. 1.

FIG. 4 is a front view of a first LED array module.

FIG. 5 is a front view of a second LED array module.

FIG. 6 is a side view of the LED array module of FIG. 4 showing a first LED carried by a first circuit board.

FIG. 7 is a side view of the LED array module of FIG. 5 showing a second LED carried by a second circuit board.

FIGS. 8 and 9 are perspective views of an LED module.

FIG. 10 is a side view of the LED module of FIGS. 8 and 9 carrying a plurality of the LED array modules of FIG. 4.

FIG. 11 is a side view of the LED module of FIGS. 8 and 9 carrying a plurality of the LED array modules of FIG. 5.

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The embodiments disclosed herein may include a current conditioning system for controlling the current flow through a light emitting diode (LED). The current conditioning system operates in response to applying a low voltage. The low voltage can be of many different values, such as about 60 VDC. The current conditioning system can drive one or more discrete LED devices, and it can drive LED strip lighting. The current conditioning system can drive one or more LED array modules. In some embodiments, the current conditioning system includes ten or more LED array modules. In some embodiments, each LED array module includes a current conditioning circuit carried on the same circuit board as the LEDs.

The current conditioning circuit controls the amount of current that flows through the LEDs. The current conditioning system still operates if one or more of the LED array modules fail to operate. The current conditioning system protects the LEDs from overheating if a cooling system shuts down or fails.

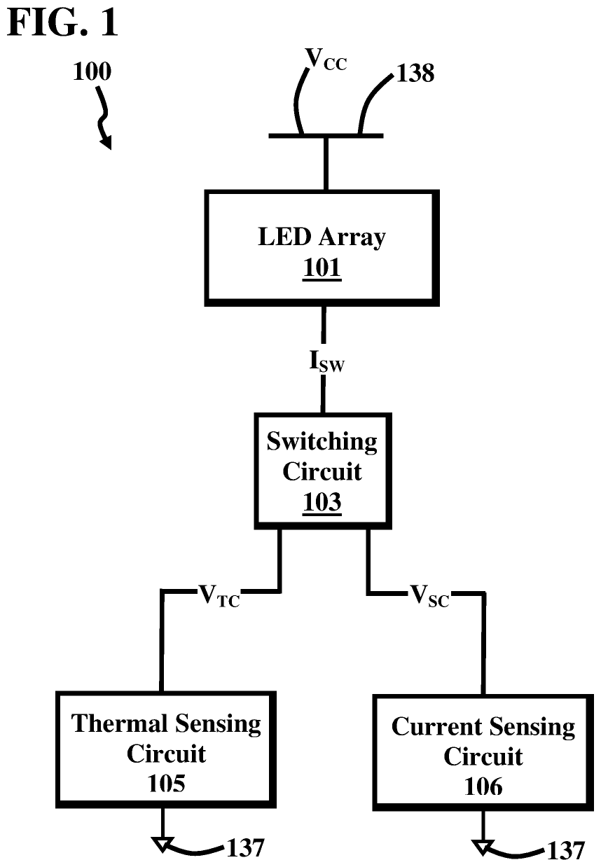

FIG. 1 is a block diagram of a current conditioning system 100. In this embodiment, the current conditioning system 100 includes an LED array 101 in communication with a switching circuit 103. The switching circuit 103 is in communication with a thermal-sensing circuit 105 and current-sensing circuit 106. The LED array 101 is connected to a terminal 138, and the thermal-sensing circuit 105 and current-sensing circuit 106 are connected to a current return 137. It should be noted that the currents and voltages of the current conditioning system 100 are established in response to applying a voltage VCC to the terminal 138, wherein the voltage VCC is referenced at the current return 137. The voltage VCC can have many different values. In this embodiment, the voltage VCC is less than or equal to 60 VDC. It should be noted that the value of the voltage VCC depends on the power requirements of the current conditioning system 100.

In operation, a switching current ISW flows through the LED array 101 in response to the switching circuit 103 having an ON condition. The LED array 101 provides light in response to enough of the switching current ISW flowing therethrough. The LED array 101 provides light in response to the switching current ISW being driven above a threshold current. In general, the LED array 101 provides light in response to the switching current ISW being greater than or equal to the threshold current. The switching current ISW does not flow through the LED array 101 in response to the switching circuit 103 having an OFF condition. The LED array 101 does not provide light in response to not enough of the switching current ISW flowing therethrough. The LED array 101 does not provide light in response to the switching current ISW being driven below the threshold current. In general, the LED array 101 does not provide light in response to the switching current ISW being less than the threshold current.

It should be noted that the switching circuit 103 is repeatably moveable between the ON and OFF conditions. The switching circuit 103 can be moved between the ON and OFF conditions in many different ways. In this embodiment, the switching circuit 103 is moved between the ON and OFF conditions in response to a temperature indication. The switching circuit 103 moves to the ON condition in response to the temperature indication being below a predetermined temperature value. The switching circuit 103 moves to the OFF condition in response to the temperature indication being above the predetermined temperature value.

In this embodiment, the temperature indication corresponds to the temperature of the thermal-sensing circuit 105. A thermal-sensing voltage VTC is adjustable in response to adjusting the temperature indication. In one embodiment, the thermal-sensing voltage VTC increases in response to the temperature indication being increased, and the thermal-sensing voltage VTC decreases in response to the temperature indication being decreased.

In one situation, the switching circuit 103 has the ON condition in response to the thermal-sensing voltage VTC having a first predetermined voltage threshold value. The switching current ISW increases in response to the switching circuit 103 being driven to the ON condition. The LED array 101 provides more light in response to the switching current ISW increasing. In particular, the LED array 101 provides more light in response to the switching current ISW increasing above the threshold current.

In another situation, the switching circuit 103 has the OFF condition in response to the thermal-sensing voltage VTC being less than the first predetermined voltage threshold value. The switching current ISW decreases in response to the switching circuit 103 being driven to the OFF condition. The LED array 101 provides less light in response to the switching current ISW decreasing. In particular, the LED array 101 provides less light in response to the switching current ISW decreasing below the threshold current. In this way, the switching current ISW can be adjusted in response to adjusting the thermal-sensing voltage VTC with the temperature indication.

In this embodiment, the switching circuit 103 is moved between the ON and OFF conditions in response to a voltage indication. The switching circuit 103 moves to the ON condition in response to the voltage indication being below a second predetermined voltage threshold value. The switching circuit 103 moves to the OFF condition in response to the voltage indication being above the second predetermined voltage threshold value. It should be noted that the switching circuit 103 can be moved between the ON and OFF conditions in response to other types of indications. For example, in some embodiments, the switching circuit 103 is moved between the ON and OFF conditions in response to a current indication. In some embodiments, the switching circuit 103 is moved between the ON and OFF conditions in response to a power indication.

In this embodiment, the voltage indication corresponds to the voltage of the current-sensing circuit 106. A sensing voltage VSC is adjustable in response to adjusting the current indication. In one embodiment, the sensing voltage VSC increases in response to the current indication being increased, and the sensing voltage VSC decreases in response to the current indication being decreased.

In one situation, the switching circuit 103 has the ON condition in response to the sensing voltage VSC having the second predetermined voltage threshold value. The switching current ISW increases in response to the switching circuit 103 being driven to the ON condition. The LED array 101 provides more light in response to the switching current ISW increasing. In particular, the LED array 101 provides more light in response to the switching current ISW increasing above the second predetermined voltage threshold value.

In another situation, the switching circuit 103 has the OFF condition in response to the sensing voltage VSC being less than the second predetermined voltage threshold value. The switching current ISW decreases in response to the switching circuit 103 being driven to the OFF condition. The LED array 101 provides less light in response to the switching current ISW decreasing. In particular, the LED array 101 provides less light in response to the switching current ISW decreasing below the second predetermined voltage threshold value. In this way, the switching current ISW can be adjusted in response to adjusting the sensing voltage VSC with the current indication.

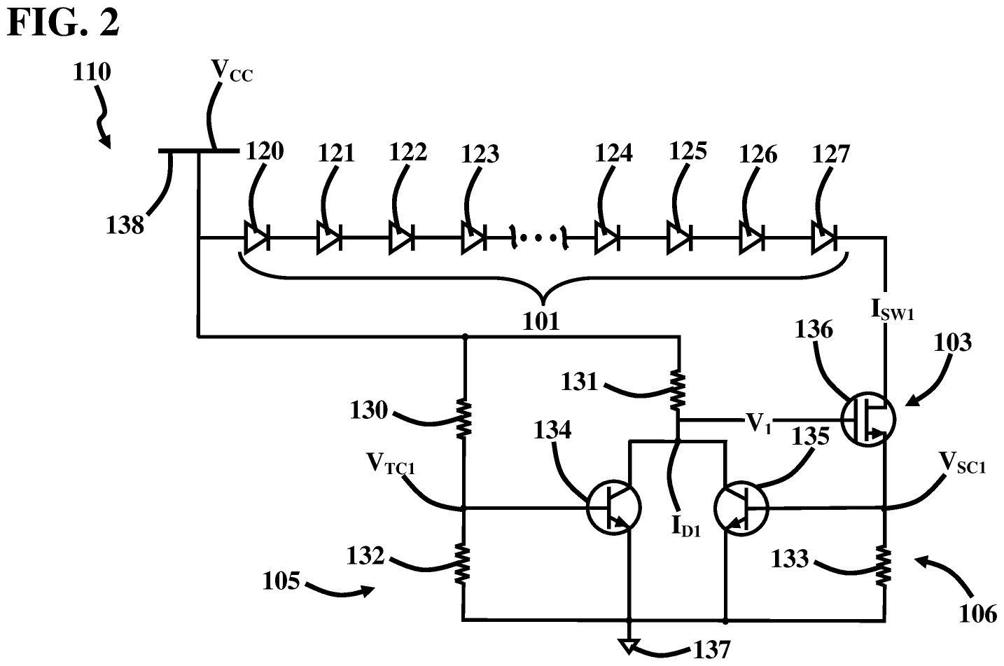

FIG. 2 is a circuit diagram of a current conditioning circuit 110, which corresponds to the current conditioning system 100 of FIG. 1. It should be noted that the current conditioning circuit 110 includes the terminal 138 and current return 137, and is provided power in response to applying the potential difference VCC (FIG. 1) between the terminal 138 and current return 137.

In this embodiment, the current conditioning circuit 110 includes the LED array 101. The LED array 101 can be of many different types. In this embodiment, the LED array 101 includes an LED which provides light in response to receiving a current. In general, the LED array 101 includes one or more LEDs. In this embodiment, the LED array 101 includes a plurality of LEDs, denoted as LED 120, LED 121, LED, 122, LED 123, LED 124, LED, 125, LED 126, and LED 127, wherein the LEDs of the LED array 101 are connected in series. In other embodiments, the LEDs of the LED array 101 are connected in parallel. In some embodiments, the LEDs of the LED array 101 are connected in series-parallel. It should be noted that the positive terminal of the LED 120 is connected to the terminal 138. Further, the negative terminal of the LED 127 is connected to the switching circuit 103, as will be discussed in more detail below.

In this embodiment, the current conditioning circuit 110 includes the switching circuit 103 in communication with the thermal-sensing circuit 105 and current-sensing circuit 106. In this embodiment, the switching circuit 103 includes a transistor 136 having a drain terminal connected to the negative terminal of the LED 127. The transistor 136 includes a source terminal connected to a first terminal of a current-sensing resistor 133, wherein the current-sensing resistor 133 has a second terminal connected to the current return 137. The transistor 136 includes a control terminal connected to a first terminal of a biasing resistor 131, wherein a second terminal of the biasing resistor 131 is connected to the terminal 138.

In this embodiment, the current conditioning circuit 110 includes a transistor 135, having a base terminal connected to the first terminal of the resistor 133 and the source terminal of the transistor 136. The transistor 135 includes a collector terminal connected to the first terminal of the biasing resistor 131. The transistor 135 includes an emitter terminal connected to the current return 137 and the second terminal of the current-sensing resistor 133.

In this embodiment, the current conditioning circuit 110 includes a transistor 134, having a base terminal connected to the first terminal of the resistor 131 and the source terminal of the transistor 136. The transistor 134 includes a collector terminal connected to a first terminal of a thermal-sensing resistor 132, wherein the thermal-sensing resistor 132 includes a second terminal connected to the current return 137. The transistor 134 includes an emitter terminal connected to the current return 137 and the second terminal of the thermal-sensing resistor 132. One example of a thermal-sensing resistor is a thermistor. In general, the resistance of the thermal-sensing resistor 132 is adjustable in response to adjusting the temperature thereof. In this embodiment, the resistance of the thermal-sensing resistor 132 increases in response to the temperature increasing. Further, the resistance of the thermal-sensing resistor 132 decreases in response to the temperature decreasing.

In this embodiment, the current conditioning circuit 110 includes a biasing resistor 130 with a first terminal connected to the base of the transistor 134 and the first terminal of the thermal-sensing resistor 132. The biasing resistor 130 includes a second terminal connected to the terminal 138 and the second terminal of the resistor 131. In this way, the second terminals of the biasing resistors 130 and 131 are connected together. It should be noted that the thermal-sensing circuit 105 includes the biasing resistor 130, thermal-sensing resistor 132, and transistor 134. Further, the current-sensing circuit 106 includes the biasing resistor 131, current-sensing resistor 133, and transistor 135.

It should be noted that the switching circuit 103 includes the transistor 136. The transistor 136 can be of many different types, such as a metal oxide field effect transistor (MOSFET). The thermal-sensing circuit 105 includes the transistor 134, biasing resistor 130, and thermal-sensing resistor 132. The transistor 134 can be of many different types, such as a bipolar junction transistor (BJT). The current-sensing circuit 106 includes the transistor 135, biasing resistor 131, and current-sensing resistor 133. The transistor 135 can be of many different types, such as a bipolar junction transistor (BJT).

In operation, the switching current ISW1 flows through the LED array 101 in response to the switching circuit 103 having an ON condition. The LED array 101 provides light in response to enough of the switching current ISW1 flowing therethrough. The LED array 101 provides light in response to the switching current ISW1 being driven above a threshold current. In general, the LED array 101 provides light in response to the switching current ISW1 being greater than or equal to the threshold current. The switching current ISW1 does not flow through the LED array 101 in response to the switching circuit 103 having an OFF condition. The LED array 101 does not provide light in response to not enough of the switching current ISW1 flowing therethrough. The LED array 101 does not provide light in response to the switching current ISW1 being driven below the threshold current. In general, the LED array 101 does not provide light in response to the switching current ISW1 being less than the threshold current.

It should be noted that the transistor 136 is repeatably moveable between the ON and OFF conditions. The transistor 136 can be moved between the ON and OFF conditions in many different ways. In this embodiment, the transistor 136 is moved between the ON and OFF conditions in response to the temperature indication. The transistor 136 moves to the ON condition in response to the temperature indication being below the predetermined temperature value. The transistor 136 moves to the OFF condition in response to the temperature indication being above the predetermined temperature value.

In this embodiment, the temperature indication corresponds to the temperature of the thermal-sensing resistor 132. The thermal-sensing voltage VTC1, provided to the transistor 134, is adjustable in response to adjusting the temperature indication. In one embodiment, the thermal-sensing voltage VTC1 increases in response to the temperature indication being increased, and the thermal-sensing voltage VTC1 decreases in response to the temperature indication being decreased.

In one situation, the transistor 136 has the ON condition in response to the thermal-sensing voltage VTC1 being driven to a value greater than or equal to a third predetermined voltage threshold value. The switching current ISW1 increases in response to the transistor 136 being driven to the ON condition. The LED array 101 provides more light in response to the switching current ISW1 increasing. In particular, the LED array 101 provides more light in response to the switching current ISW1 increasing above the threshold current.

In another situation, the transistor 136 has the OFF condition in response to the thermal-sensing voltage VTC1 being less than the third predetermined voltage threshold value. The switching current ISW1 decreases in response to the transistor 136 being driven to the OFF condition. The LED array 101 provides less light in response to the switching current ISW1 decreasing. In particular, the LED array 101 provides less light in response to the switching current ISW1 decreasing below the threshold current. In this way, the switching current ISW1 can be adjusted in response to adjusting the thermal-sensing voltage VTC1 with the temperature indication.

It should be noted that the transistor 134 is moved between ON and OFF conditions in response to adjusting the thermal-sensing voltage VTC1. Further, the transistor 136 is moved between the ON and OFF conditions in response to adjusting a voltage V1 at the control terminal of the transistor 136.

The voltage V1 is driven to the potential of the current return 137 in response to the transistor 134 having an ON condition. The transistor 136 is moved to the OFF condition in response to driving the voltage V1 to the potential of the current return 137. The voltage V1 is driven away from the potential of the current return 137 in response to the transistor 134 having an OFF condition. The transistor 136 is moved to the ON condition in response to driving the voltage V1 away from the potential of the current return 137.

In this embodiment, the transistor 136 is moved between the ON and OFF conditions in response to the voltage indication. The transistor 136 moves to the ON condition in response to the voltage indication being below the second predetermined voltage threshold value. The transistor 136 moves to the OFF condition in response to the voltage indication being above the second predetermined voltage threshold value.

In this embodiment, the voltage indication corresponds to the voltage of the current-sensing resistor 133. The sensing voltage VSC1, provided to the transistor 135 by the current-sensing circuit 106, is adjustable in response to adjusting the current indication. In one embodiment, the sensing voltage VSC1 increases in response to the current indication being increased, and the sensing voltage VSC1 decreases in response to the current indication being decreased.

In one situation, the switching circuit 103 has the ON condition in response to the sensing voltage VSC1 having the second predetermined voltage threshold value. The switching current ISW1 increases in response to the switching circuit 103 being driven to the ON condition. The LED array 101 provides more light in response to the switching current ISW1 increasing. In particular, the LED array 101 provides more light in response to the switching current ISW1 increasing above the second predetermined voltage threshold value.

In another situation, the switching circuit 103 has the OFF condition in response to the sensing voltage VSC1 being less than the second predetermined voltage threshold value. The switching current ISW1 decreases in response to the switching circuit 103 being driven to the OFF condition. The LED array 101 provides less light in response to the switching current ISW1 decreasing. In particular, the LED array 101 provides less light in response to the switching current ISW1 decreasing below the second predetermined voltage threshold value. In this way, the switching current ISW1 can be adjusted in response to adjusting the sensing voltage VSC1 with the current indication.

It should be noted that the transistor 135 is moved between ON and OFF conditions in response to adjusting the sensing voltage VSC1. Further, the transistor 136 is moved between the ON and OFF conditions in response to adjusting the voltage V1 at the control terminal of the transistor 136.

The voltage V1 is driven to the potential of the current return 137 in response to the transistor 135 having an ON condition. The transistor 136 is moved to the OFF condition in response to driving the voltage V1 to the potential of the current return 137. The voltage V1 is driven away from the potential of the current return 137 in response to the transistor 134 having an OFF condition. The transistor 136 is moved to the ON condition in response to driving the voltage V1 away from the potential of the current return 137.

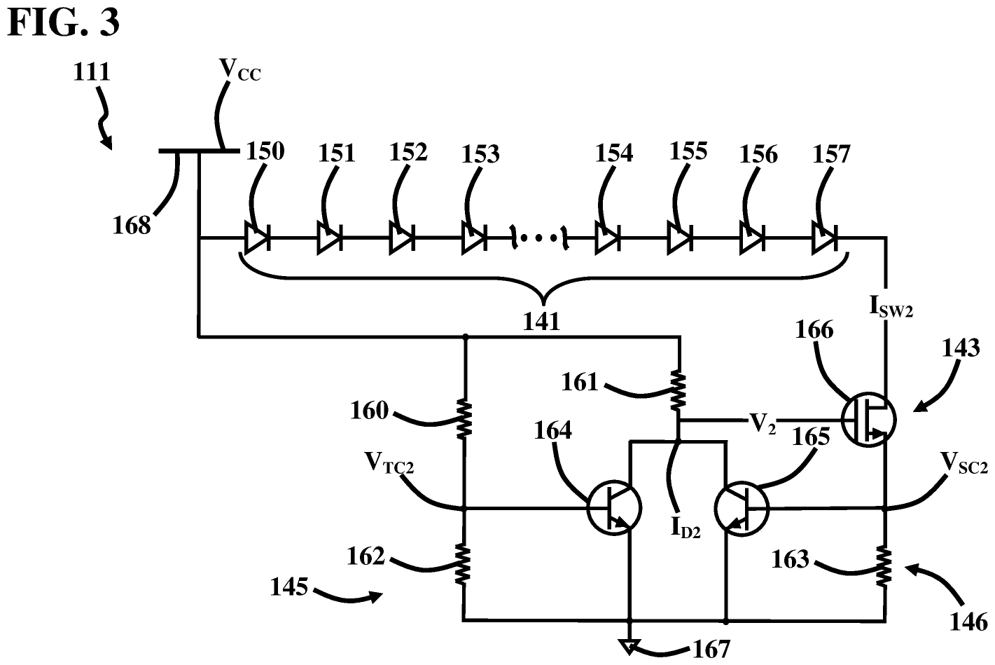

FIG. 3 is a circuit diagram of a current conditioning circuit 111, which corresponds to the current conditioning system 100 of FIG. 1. It should be noted that the current conditioning circuit 111 includes a terminal 168 and current return 167, and is provided power in response to applying the potential difference VCC (FIG. 1) between the terminal 168 and current return 167.

In this embodiment, the current conditioning circuit 111 includes the LED array 141. The LED array 141 can be of many different types. In this embodiment, the LED array 141 includes an LED which provides light in response to receiving a current. In general, the LED array 141 includes one or more LEDs. In this embodiment, the LED array 141 includes a plurality of LEDs, denoted as LED 150, LED 151, LED, 152, LED 153, LED 154, LED, 155, LED 156, and LED 157, wherein the LEDs of the LED array 141 are connected in series. In other embodiments, the LEDs of the LED array 141 are connected in parallel. In some embodiments, the LEDs of the LED array 141 are connected in series-parallel. It should be noted that the positive terminal of the LED 150 is connected to the terminal 168. Further, the negative terminal of the LED 147 is connected to the switching circuit 143, as will be discussed in more detail below.

In this embodiment, the current conditioning circuit 111 includes the switching circuit 143 in communication with the thermal-sensing circuit 145 and current-sensing circuit 146. In this embodiment, the switching circuit 143 includes a transistor 166 having a drain terminal connected to the negative terminal of the LED 157. The transistor 166 includes a source terminal connected to a first terminal of a current-sensing resistor 163, wherein the current-sensing resistor 163 has a second terminal connected to the current return 167. The transistor 166 includes a control terminal connected to a first terminal of a biasing resistor 161, wherein a second terminal of the biasing resistor 161 is connected to the terminal 168.

In this embodiment, the current conditioning circuit 111 includes a transistor 165, having a base terminal connected to the first terminal of the resistor 163 and the source terminal of the transistor 166. The transistor 165 includes a collector terminal connected to the first terminal of the biasing resistor 161. The transistor 165 includes an emitter terminal connected to the current return 167 and the second terminal of the current-sensing resistor 163.

In this embodiment, the current conditioning circuit 111 includes a transistor 164, having a base terminal connected to the first terminal of the resistor 161 and the source terminal of the transistor 166. The transistor 164 includes a collector terminal connected to a first terminal of a thermal-sensing resistor 162, wherein the thermal-sensing resistor 162 includes a second terminal connected to the current return 167. The transistor 164 includes an emitter terminal connected to the current return 167 and the second terminal of the thermal-sensing resistor 162. One example of a thermal-sensing resistor is a thermistor. In general, the resistance of the thermal-sensing resistor 162 is adjustable in response to adjusting the temperature thereof. In this embodiment, the resistance of the thermal-sensing resistor 162 increases in response to the temperature increasing. Further, the resistance of the thermal-sensing resistor 162 decreases in response to the temperature decreasing.

In this embodiment, the current conditioning circuit 111 includes a biasing resistor 160 with a first terminal connected to the base of the transistor 164 and the first terminal of the thermal-sensing resistor 162. The biasing resistor 160 includes a second terminal connected to the terminal 168 and the second terminal of the resistor 161. In this way, the second terminals of the biasing resistors 160 and 161 are connected together. It should be noted that the thermal-sensing circuit 145 includes the biasing resistor 160, thermal-sensing resistor 162, and transistor 164. Further, the current-sensing circuit 146 includes the biasing resistor 161, current-sensing resistor 163, and transistor 165.

It should be noted that the switching circuit 143 includes the transistor 166. The transistor 166 can be of many different types, such as a metal oxide field effect transistor (MOSFET). The thermal-sensing circuit 145 includes the transistor 164, biasing resistor 160, and thermal-sensing resistor 162. The transistor 164 can be of many different types, such as a bipolar junction transistor (BJT). The current-sensing circuit 146 includes the transistor 165, biasing resistor 161, and current-sensing resistor 163. The transistor 165 can be of many different types, such as a bipolar junction transistor (BJT).

In operation, the switching current ISW2 flows through the LED array 141 in response to the switching circuit 143 having an ON condition. The LED array 141 provides light in response to enough of the switching current ISW2 flowing therethrough. The LED array 141 provides light in response to the switching current ISW2 being driven above a threshold current. In general, the LED array 141 provides light in response to the switching current ISW2 being greater than or equal to the threshold current. The switching current ISW2 does not flow through the LED array 141 in response to the switching circuit 143 having an OFF condition. The LED array 141 does not provide light in response to not enough of the switching current ISW2 flowing therethrough. The LED array 141 does not provide light in response to the switching current ISW2 being driven below the threshold current. In general, the LED array 141 does not provide light in response to the switching current ISW2 being less than the threshold current.

It should be noted that the transistor 166 is repeatably moveable between the ON and OFF conditions. The transistor 166 can be moved between the ON and OFF conditions in many different ways. In this embodiment, the transistor 166 is moved between the ON and OFF conditions in response to the temperature indication. The transistor 166 moves to the ON condition in response to the temperature indication being below the predetermined temperature value. The transistor 166 moves to the OFF condition in response to the temperature indication being above the predetermined temperature value.

In this embodiment, the temperature indication corresponds to the temperature of the thermal-sensing resistor 162. The thermal-sensing voltage VTC2, provided to the transistor 164, is adjustable in response to adjusting the temperature indication. In one embodiment, the thermal-sensing voltage VTC2 increases in response to the temperature indication being increased, and the thermal-sensing voltage VTC2 decreases in response to the temperature indication being decreased.

In one situation, the transistor 166 has the ON condition in response to the thermal-sensing voltage VTC2 being driven to a value greater than or equal to a third predetermined voltage threshold value. The switching current ISW2 increases in response to the transistor 166 being driven to the ON condition. The LED array 141 provides more light in response to the switching current ISW2 increasing. In particular, the LED array 141 provides more light in response to the switching current ISW1 increasing above the threshold current.

In another situation, the transistor 166 has the OFF condition in response to the thermal-sensing voltage VTC2 being less than the third predetermined voltage threshold value. The switching current ISW2 decreases in response to the transistor 166 being driven to the OFF condition. The LED array 141 provides less light in response to the switching current ISW2 decreasing. In particular, the LED array 141 provides less light in response to the switching current ISW2 decreasing below the threshold current. In this way, the switching current ISW2 can be adjusted in response to adjusting the thermal-sensing voltage VTC2 with the temperature indication.

It should be noted that the transistor 164 is moved between ON and OFF conditions in response to adjusting the thermal-sensing voltage VTC2. Further, the transistor 166 is moved between the ON and OFF conditions in response to adjusting a voltage V2 at the control terminal of the transistor 166.

The voltage V2 is driven to the potential of the current return 167 in response to the transistor 164 having an ON condition. The transistor 166 is moved to the OFF condition in response to driving the voltage V2 to the potential of the current return 167. The voltage V2 is driven away from the potential of the current return 167 in response to the transistor 164 having an OFF condition. The transistor 166 is moved to the ON condition in response to driving the voltage V2 away from the potential of the current return 167.

In this embodiment, the transistor 166 is moved between the ON and OFF conditions in response to the voltage indication. The transistor 166 moves to the ON condition in response to the voltage indication being below the second predetermined voltage threshold value. The transistor 166 moves to the OFF condition in response to the voltage indication being above the second predetermined voltage threshold value.

In this embodiment, the voltage indication corresponds to the voltage of the current-sensing resistor 163. The sensing voltage VSC2, provided to the transistor 165 by the current-sensing circuit 146, is adjustable in response to adjusting the current indication. In one embodiment, the sensing voltage VSC2 increases in response to the current indication being increased, and the sensing voltage VSC2 decreases in response to the current indication being decreased.

In one situation, the switching circuit 143 has the ON condition in response to the sensing voltage VSC2 having the second predetermined voltage threshold value. The switching current ISW2 increases in response to the switching circuit 143 being driven to the ON condition. The LED array 141 provides more light in response to the switching current ISW2 increasing. In particular, the LED array 141 provides more light in response to the switching current ISW2 increasing above the second predetermined voltage threshold value.

In another situation, the switching circuit 143 has the OFF condition in response to the sensing voltage VSC2 being less than the second predetermined voltage threshold value. The switching current ISW2 decreases in response to the switching circuit 143 being driven to the OFF condition. The LED array 141 provides less light in response to the switching current ISW2 decreasing. In particular, the LED array 141 provides less light in response to the switching current ISW2 decreasing below the second predetermined voltage threshold value. In this way, the switching current ISW2 can be adjusted in response to adjusting the sensing voltage VSC2 with the current indication.

It should be noted that the transistor 165 is moved between ON and OFF conditions in response to adjusting the sensing voltage VSC2. Further, the transistor 166 is moved between the ON and OFF conditions in response to adjusting the voltage V2 at the control terminal of the transistor 166.

The voltage V2 is driven to the potential of the current return 167 in response to the transistor 165 having an ON condition. The transistor 166 is moved to the OFF condition in response to driving the voltage V2 to the potential of the current return 167. The voltage V2 is driven away from the potential of the current return 167 in response to the transistor 164 having an OFF condition. The transistor 166 is moved to the ON condition in response to driving the voltage V2 away from the potential of the current return 167.

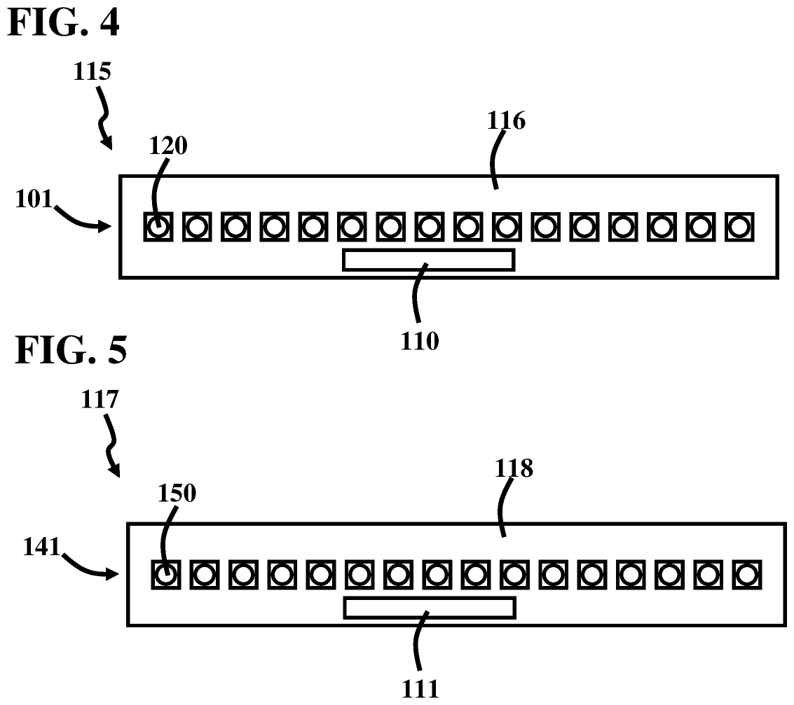

FIG. 4 is a front view of a LED array module 115. In this embodiment, the LED array module 115 includes a circuit board 116, which carries the LED array 101 and current conditioning circuit 110, as shown in FIG. 2. In this embodiment, the LEDs of the LED array 101 are spaced apart from each other along the length of the circuit board 116. It should be noted that, in some embodiments, the LEDs of the LED array 101 are discrete components. In other embodiments, the LED array 101 is an LED strip.

FIG. 5 is a front view of a LED array module 117. In this embodiment, the LED array module 117 includes a circuit board 118, which carries the LED array 141 and current conditioning circuit 111, as shown in FIG. 3. In this embodiment, the LEDs of the LED array 141 are spaced apart from each other along the length of the circuit board 118. It should be noted that, in some embodiments, the LEDs of the LED array 141 are discrete components. In other embodiments, the LED array 141 is an LED strip.

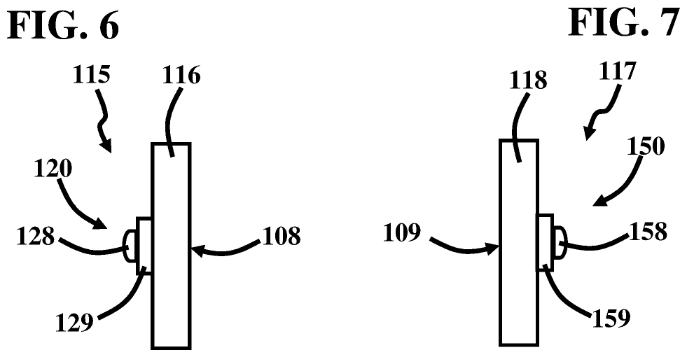

FIG. 6 is a side view of the LED array module 115 showing the LED 120 carried by the circuit board 116. In this embodiment, the LED 120 includes a housing 129 which carries a lens 128. The circuit board 116 includes a surface 108 opposed to the LED 120.

FIG. 7 is a side view of the LED array module 117 showing the LED 150 carried by the circuit board 118. In this embodiment, the LED 150 includes a housing 159 which carries a lens 158. The circuit board 116 includes a surface 109 opposed to the LED 150.

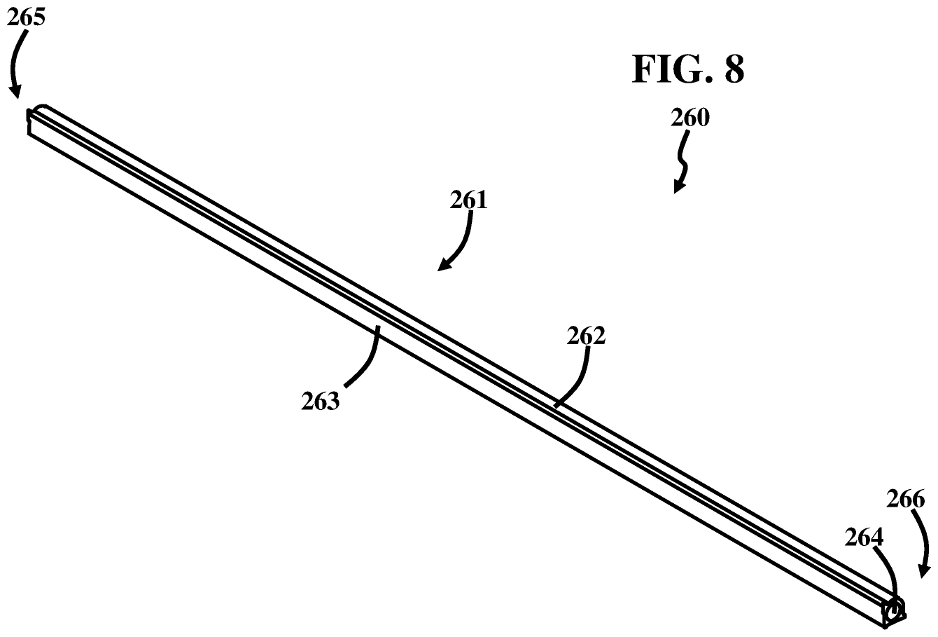

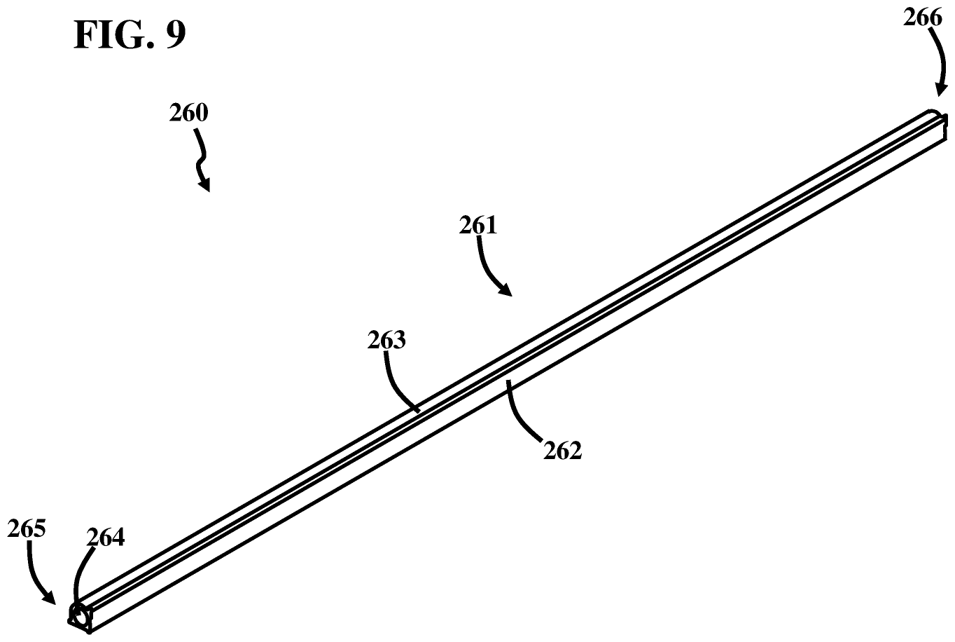

FIGS. 8 and 9 are perspective views of an LED module 260. In this embodiment, the LED module 260 includes an LED support structure 261, which extends between opposed ends 265 and 266. A channel 264 extends through the LED support structure 261 between the opposed ends 265 and 266. The LED support structure 261 includes a support surface 262 and 263. The surfaces 262 and 263 extend along the length of the LED support structure 261 between the opposed ends 265 and 266.

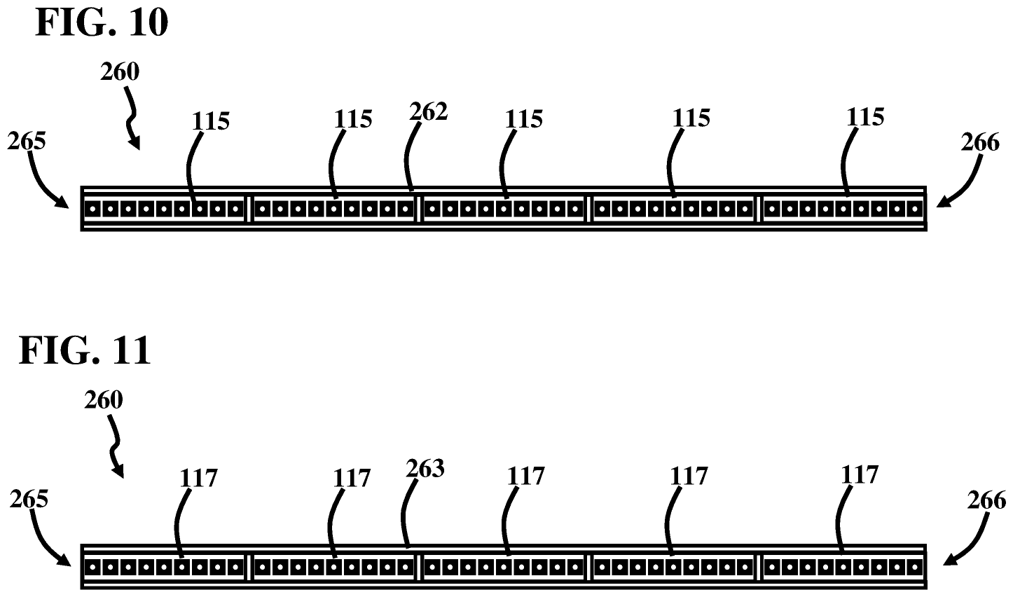

FIG. 10 is a side view of the LED module 260 of FIGS. 8 and 9. In this embodiment, a plurality of LED array modules 115 are coupled to the surface 262. In this particular embodiment, five LED array modules 115 are coupled to the surface 262 for illustrative purposes. The surface 108 of the circuit board 116 (FIG. 6) is coupled to the surface 262 of the LED support structure 261 (FIG. 9).

FIG. 11 is a side view of the LED module 260 of FIGS. 8 and 9. In this embodiment, a plurality of LED array modules 117 are coupled to the surface 263. In this particular embodiment, five LED array modules 117 are coupled to the surface 263 for illustrative purposes. The surface 109 of the circuit board 116 (FIG. 8) is coupled to the surface 263 of the LED support structure 261 (FIG. 8).

It should be noted that a material can be flowed through the channel 264 to decrease the amount of heat proximate to the LED module 260. The fluid can be of many different types, such as a gas. The gas can be of many different types, such as air. The fluid can be a liquid, such as water. In one situation, the heat flows from the LED array 101 and through the circuit board 116. The heat flows through the surfaces 108 and 262, wherein the fluid moves the heat through the channel 264. The fluid and heat can be flowed through the ends 265 and/or 266. In one situation, the heat flows from the LED array 141 and through the circuit board 118. The heat flows through the surfaces 109 and 263, wherein the fluid moves the heat through the channel 264. The fluid and heat can be flowed through the ends 265 and/or 266. In this way, the operating temperature of the LED module 260 is decreased.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

The disclosed embodiments may include the following items

1. A current conditioning system (100), comprising:

an LED support structure (261) with a channel (264) extending therethrough; and

a first LED array module (115) carried on a first surface (108) of the LED support structure (261), wherein the first LED array module (115) includes a first LED array (101) and a first current conditioning circuit (110) which adjusts the amount of current flowing through the first LED array (101) in response to a first temperature indication.

2. The system of 1, wherein the first temperature indication is adjustable in response to adjusting the flow of a material through the channel (264).

3. The system of 1, wherein the first current conditioning circuit (110) includes a first thermal sensing circuit (105) and a first current sensing circuit (106).

4. The system of 3, wherein the first thermal sensing circuit (105) adjusts the amount of current flowing through the first LED array (101) in response to the first temperature indication.

5. The system of 3, wherein the first current sensing circuit (106) adjusts the amount of current flowing through the first LED array (101) in response to a first voltage indication.

6. The system of 3, wherein the first thermal sensing circuit (105) and first current sensing circuit (106) adjust the amount of current flowing through the first LED array (101).

7. A current conditioning system (100), comprising:

an LED support structure (261) with a channel (264) extending therethrough;

a first LED array module (115) carried on a first surface (108) of the LED support structure (261), wherein the first LED array module (115) includes a first LED array (101) and a first current conditioning circuit (110) which adjusts the amount of current flowing through the first LED array (101) in response to a first temperature indication; and

a second LED array module (117) carried on a second surface (109) of the LED support structure (261), wherein the second LED array module (117) includes a second LED array (141) and a second current conditioning circuit (110) which adjusts the amount of current flowing through the second LED array (141) in response to a second temperature indication.

8. The system of 7, wherein the first and second temperature indications are adjustable in response to adjusting the flow of a material through the channel (264).

9. The system of claim 8, wherein the first current conditioning circuit (110) includes a first thermal sensing circuit (105) and a first current sensing circuit (106).

10. The system of claim 9, wherein the first thermal sensing circuit (105) adjusts the amount of current flowing through the first LED array (101) in response to the first temperature indication.

11. The system of 8, wherein the second current conditioning circuit (111) includes a second thermal sensing circuit (105) and a second current sensing circuit (106).

12. The system of 11, wherein the second thermal sensing circuit (105) adjusts the amount of current flowing through the second LED array (141) in response to the second temperature indication.

13. The system of 7, wherein the first current sensing circuit (106) adjusts the amount of current flowing through the first LED array (101) in response to a first voltage indication.

14. The system of 7, wherein the first current sensing circuit (106) adjusts the amount of current flowing through the first LED array (101) in response to a first voltage indication.

15. A current conditioning system (100), comprising:

an LED support structure (261) with a channel (264) extending therethrough; and

an LED array module (115) carried on a surface (108) of the LED support structure (261), wherein the LED array module (115) includes an LED array (101) and a current conditioning circuit (110) which adjusts the amount of current flowing through the LED array (101) in response to a temperature indication.

16. The system of 15, wherein the temperature indication is adjustable in response to adjusting the flow of a material through the channel (264).

17. The system of 15, wherein the current conditioning circuit (110) adjusts the amount of current flowing through the LED array (101) in response to a voltage indication.

18. The system of 15, wherein the current conditioning circuit (110) includes a thermal sensing circuit (105) and a current sensing circuit (106).

19. The system of 18, wherein the first thermal sensing circuit (105) and first current sensing circuit (106) adjust the amount of current flowing through the first LED array (101).

20. The system of 18, wherein the current conditioning circuit (110) includes a switching circuit (103), the thermal sensing circuit (105) and current sensing circuit (106) adjusting the amount of current flowing through the switching circuit (103).

What is claimed is:

1. A current conditioning system (100), comprising:
an LED support structure (261) with a channel (264) extending therethrough; and
a first LED array module (115) carried on a first surface (108) of the LED support structure (261), wherein the first LED array module (115) includes a first LED array (101) and a first current conditioning circuit (110) which adjusts the amount of current flowing through the first LED array (101) in response to a first temperature indication.

2. The system of claim 1, wherein the first temperature indication is adjustable in response to adjusting the flow of a material through the channel (264).

3. The system of claim 1, wherein the first current conditioning circuit (110) includes a first thermal sensing circuit (105) and a first current sensing circuit (106).

4. The system of claim 3, wherein the first thermal sensing circuit (105) adjusts the amount of current flowing through the first LED array (101) in response to the first temperature indication.

5. The system of claim 3, wherein the first current sensing circuit (106) adjusts the amount of current flowing through the first LED array (101) in response to a first voltage indication.

6. The system of claim 3, wherein the first thermal sensing circuit (105) and first current sensing circuit (106) adjust the amount of current flowing through the first LED array (101).

7. A current conditioning system (100), comprising:
a LED support structure (261) with a channel (264) extending therethrough;
a first LED array module (115) carried on a first surface (108) of the LED support structure (261), wherein the first LED array module (115) includes a first LED array (101) and a first current conditioning circuit (110) which adjusts the amount of current flowing through the first LED array (101) in response to a first temperature indication; and
a second LED array module (117) carried on a second surface (109) of the LED support structure (261), wherein the second LED array module (117) includes a second LED array (141) and a second current conditioning circuit (110) which adjusts the amount of current flowing through the second LED array (141) in response to a second temperature indication.

8. The system of claim 7, wherein the first and second temperature indications are adjustable in response to adjusting the flow of a material through the channel (264).

9. The system of claim 8, wherein the first current conditioning circuit (110) includes a first thermal sensing circuit (105) and a first current sensing circuit (106).

10. The system of claim 9, wherein the first thermal sensing circuit (105) adjusts the amount of current flowing through the first LED array (101) in response to the first temperature indication.

11. The system of claim 8, wherein the second current conditioning circuit (111) includes a second thermal sensing circuit (105) and a second current sensing circuit (106).

12. The system of claim 11, wherein the second thermal sensing circuit (105) adjusts the amount of current flowing through the second LED array (141) in response to the second temperature indication.

13. The system of claim 7, wherein the first current sensing circuit (106) adjusts the amount of current flowing through the first LED array (101) in response to a first voltage indication.

14. The system of claim 7, wherein the first current sensing circuit (106) adjusts the amount of current flowing through the first LED array (101) in response to a first voltage indication.

15. A current conditioning system (100), comprising:
an LED support structure (261) with a channel (264) extending therethrough; and
an LED array module (115) carried on a surface (108) of the LED support structure (261), wherein the LED array module (115) includes an LED array (101) and a current conditioning circuit (110) which adjusts the amount of current flowing through the LED array (101) in response to a temperature indication.

16. The system of claim 15, wherein the temperature indication is adjustable in response to adjusting the flow of a material through the channel (264).

17. The system of claim 15, wherein the current conditioning circuit (110) adjusts the amount of current flowing through the LED array (101) in response to a voltage indication.

18. The system of claim 15, wherein the current conditioning circuit (110) includes a thermal sensing circuit (105) and a current sensing circuit (106).

19. The system of claim 18, wherein the first thermal sensing circuit (105) and first current sensing circuit (106) adjust the amount of current flowing through the first LED array (101).

20. The system of claim 18, wherein the current conditioning circuit (110) includes a switching circuit (103), the thermal sensing circuit (105) and current sensing circuit (106) adjusting the amount of current flowing through the switching circuit (103).
